(19) United States
(12) Patent Application Publication
(10) Pub. No.: US 2004/0211305 A1
(43) Pub. Date: Oct. 28, 2004

(54) Oscillating saw

(76) Inventor: Helmut Scholz, Triftern-Neukirchen (DE)

Correspondence Address: MCGLEW & TUTTLE, PC, 1 SCARBOROUGH STATION PLAZA, SCARBOROUGH, NY, 10510-0827, US

(21) Appl. No.: 10/779,311

(22) Filed: Feb. 12, 2004

(30) Foreign Application Priority Data
Apr. 23, 2003 (DE) 103 18 479.1

(51) Int. Cl. B26D 7/02

(52) U.S. Cl. 83/452; 83/663

(57) ABSTRACT

A saw head (2) in an oscillating saw is tiltable in relation to a bottom plate (1), at which a rotatable disk (3) with a clamping device (20, 21, 22) for the workpiece W is arranged. To reach a favorable position of a saw tool (10) of the saw head (2) in relation to a workpiece W during the operation, the saw head (2) is linearly and horizontally displaceable at the bottom plate (1) such that the distance between the chucked workpiece W and the saw tool (10) is minimal.

### FIELD OF THE INVENTION

The present invention pertains to an oscillating saw with a saw head, which can be tilted around a horizontal tilt axis in relation to a bottom plate and carries a saw tool, and with a disk, which is rotatable at the bottom plate around a vertical axis and at which a clamping device for a workpiece is arranged.

### BACKGROUND OF THE INVENTION

Such an oscillating saw is known on the market and is known from the catalog “PROXXON Gerate mit Charakter, 2003” under the name KG 220. The saw head is tiltable but not rotatable. What is tiltable is the disk carrying a clamping device. The clamping device has a fixed clamping jaw, which is beveled on the front side, and an adjustable clamping jaw. The disk can be pivoted to one side only. A miter cut is possible as a result, but a countermiter cannot be cut without rechucking the workpiece. A broad workpiece is correspondingly displaced in relation to the center of the axis of rotation of the saw tool. In addition, the distance between the saw tool and the clamping site of the workpiece changes depending on the rotation position of the disk. As a result, the sawing result may be compromised in such a way that the cutting sites will become unclean.

Other oscillating and miter-box saws are described in the technical journal selbst ist der Mann, das Heimwerkermagazin, 11/2002. The saw head is often rotatable and tiltable in such oscillating and miter-box saws. The workpiece is pressed against a stop either manually or by means of a collet. The saw head and the saw tool are rotatable together with a disk-shaped support surface, and the saw tool can plunge into a narrow slot of the disk-shaped support surface during the sawing operation.

The saw head is not rotatable but only tiltable in other oscillating and miter-box saws. A disk, which has a trough for plunging in the saw tool, is rotated for miter cuts. The workpiece is either pressed manually against a stop or held by means of a collet.

### SUMMARY OF THE INVENTION

The object of the present invention is to provide an oscillating saw of the type described in the introduction, in which the workpiece can be fixed in the clamping device such that the saw tool is in a favorable position in relation to the workpiece during sawing.

The above object is accomplished according to the present invention by the saw head being able to be moved linearly at the bottom plate such that the distance between a workpiece chucked in the clamping device and the saw tool is minimal. By moving the saw head or the saw tool carried by it to a closely spaced location from the clamping device in the particular rotation position of the disk carrying same, it is guaranteed that the workpiece will perform hardly any vibrations during sawing or cutting, because the saw tool acts on the workpiece at a very short distance from the chucking site. The saw head can be moved horizontally into the suitable position depending on the rotation position of the disk.

The saw head is preferably displaceable at the bottom plate in parallel to the horizontal tilt axis. The horizontal displaced position of the saw head can be set by the user by means of an operating part depending on the angle of rotation of the disk. A continuously adjustable, linear, horizontal displacement of the saw head can be achieved by means of a threaded spindle.

The clamping device preferably has a pair of clamping jaws, the clamping jaws being adjustable symmetrically and in opposite directions in relation to a center line. The clamping jaws have the same distance from the center line in each position. It is achieved as a result that the workpiece is always located favorably in relation to the saw tool regardless of its width. Consequently, workpieces of various widths can be cut cleanly in the same manner. The arrangement is preferably such that the center line intersects the vertical axis around which the disk is rotatable. The center line preferably intersects an area that is located approximately centrally under the axis of rotation of the saw tool.

It is favorable for the two clamping jaws to be mounted displaceably at the disk and to be adjusted together by means of an adjusting member mounted at the disk.

To make it possible to perform miter cuts in both directions, i.e., a straight cut, a miter cut and a countermiter cut, in a simple manner, the front sides facing the saw tool extend at the two clamping jaws at an acute angle to the center line. It is thus possible to perform miter cuts and countermiter cuts without rechucking the workpiece.

To perform miter cuts and countermiter cuts without rechucking the workpiece, the disk is rotatable by at least ±45°. The acute angles formed between the front sides of the clamping jaws and the center line are selected correspondingly and equal especially at least 45°.

To further improve the favorable position of workpieces of various widths in relation to the saw tool, at least one step, on which the particular workpiece can be placed, is formed at each of the two clamping jaws.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

FIG. 1 is a perspective view of an oscillating saw in a “miter cut” position of the disk;

FIG. 2 is a perspective view of the oscillating saw in a “countermiter cut” position of the disk; and

FIG. 3 is a sectional view with steps of the clamping device of the disk.

### DESCRIPTION OF THE PREFERRED EMBODIMENT

Referring to the drawings in particular, an oscillating saw is shown having a bottom plate 1, a saw head 2 and a disk 3. The saw head 2 is mounted at the bottom plate 1 tiltably around a tilt axis 4, which is horizontal in the position of use, in the direction of the double arrow K. The saw head 2 is horizontally displaceable along the tilt axis 4 in the direction of the double arrow V. The saw head 2 has two bearing blocks for this, between which a sleeve 6 is located, which is fastened to a threaded spindle 7. The threaded spindle 7 is mounted on a threaded piece 8 of a block 8′ of the bottom plate 1. The threaded spindle is rotatable by the user by means of an operating part 9 such that the saw head 2 moves in relation to the bottom plate 1 in the direction of the double arrow V.

A saw tool, especially a saw blade 10 or a cutting disk is rotatable at the saw head 2 around a shaft 11. A motor drive for the saw blade 10 is arranged in the saw head 2. A protective cover 12 is used to cover the saw blade 10.

A recessed grip 13 with switching elements 14 is provided at the saw head 2. The user can tilt the saw head 2 around the tilt axis 4 by means of the recessed grip 13 and the handle in order to use the saw blade.

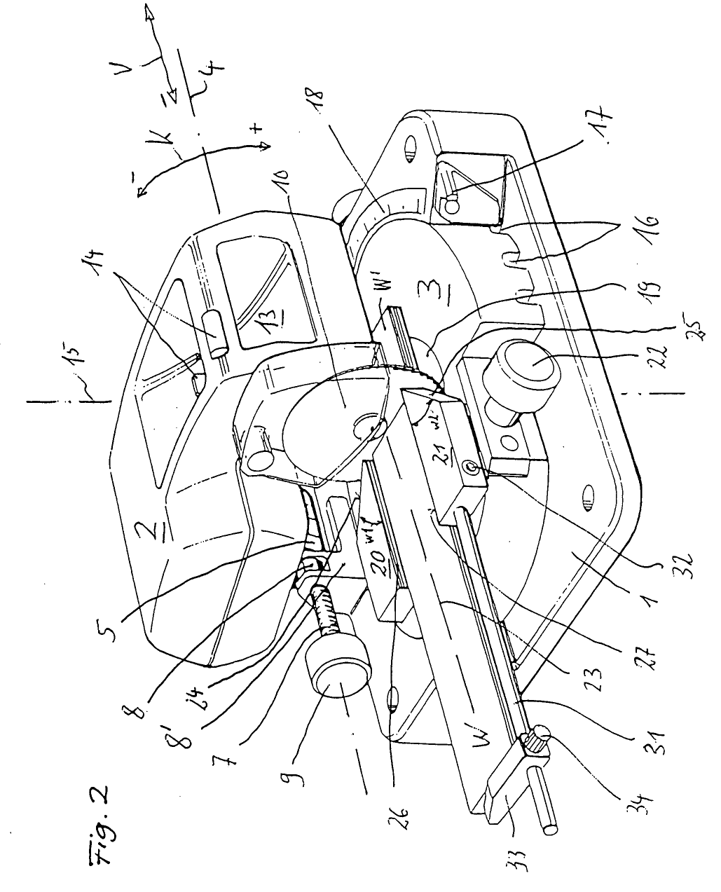

The disk 3 is rotatable at the bottom plate 1 around a vertical axis of rotation 15 in order to set the miter angle desired for the cut. Recesses 16, with which a stop grip 17 mounted at the bottom plate 1 is associated, are provided at the disk 3 for the continuously variable setting of a desired miter angle or angle of rotation of the table 3. A dial 18, with which a marking of the disk 3 is associated, is provided at the bottom plate 1 for displaying the miter angle. The disk 3 is rotatable by ±45° or more in relation to a central position (see FIG. 2).

A trough 19, which the saw blade 10 can freely enter in the possible displaced positions of the saw head 2 during the cutting of a workpiece W, is formed in the disk 3 in the area of the saw blade 10.

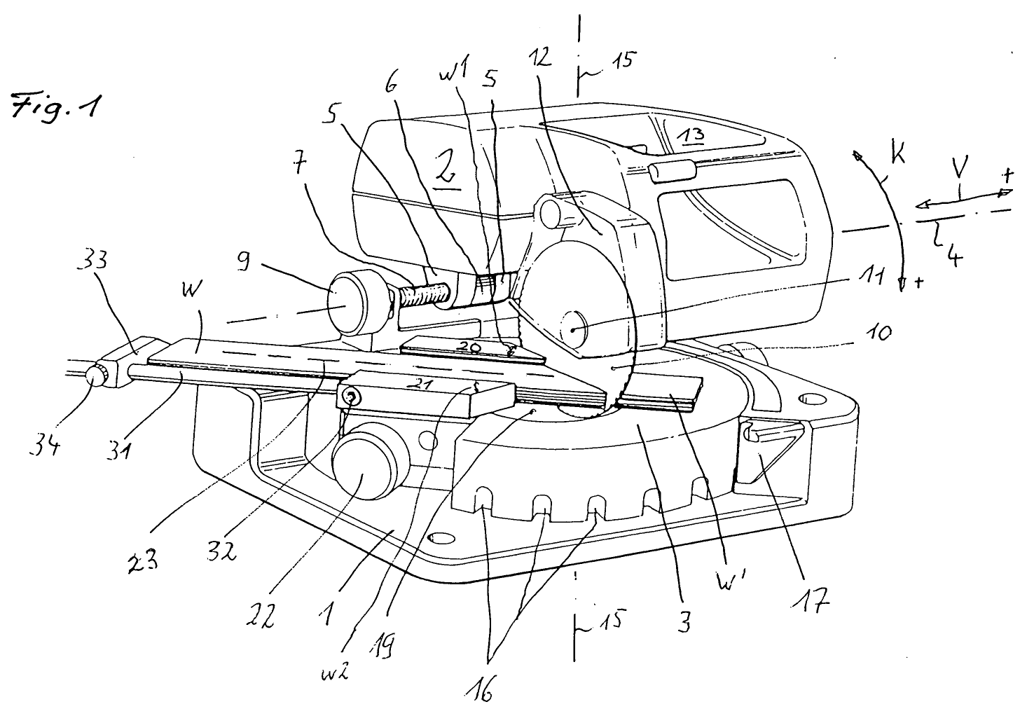

A vice, which has two clamping jaws 20, 21, is integrated as a clamping device within the disk 3. The clamping jaws 20, 21 are mounted displaceably in the disk 3 and are adjustable symmetrically in opposite directions in relation to a center line 23 by means of an adjusting member 22 arranged at the disk 3. The center line 23 intersects the vertical axis of rotation 15 of the disk 3 and passes through an area vertically centrally below the shaft 11 (see FIG. 1, FIG. 2).

Both clamping jaws 20, 21 have front sides 24, 25, which face the saw blade 10 and extend at acute angles w1 and w2, respectively, to the center line 23 (see FIG. 2). Both clamping jaws 20, 21 have the inner sides 26, 27. The inner sides 26, 27 of the clamping jaws 20, 21 are parallel to the center line 23. The acute angles w1 and w2 are adapted to the maximum possible rotation of the disk 3 in relation to the central position (see FIG. 2). If the possible rotation of the disk 3 is ±45°, the angles w1 and w2 also equal at least 45°.

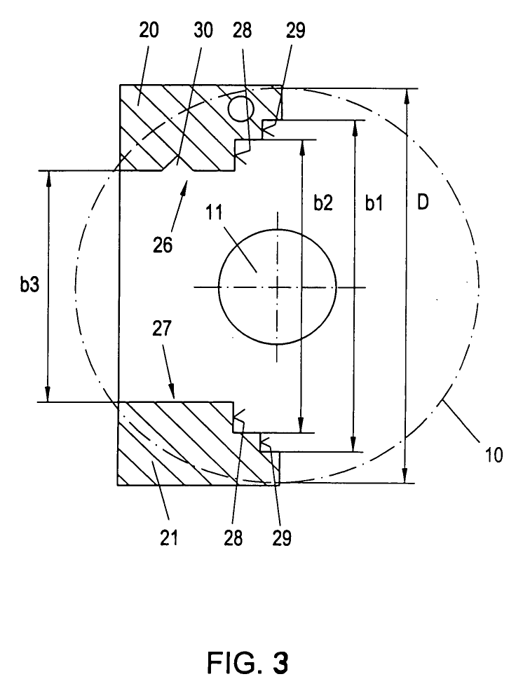

At least one step each is formed on the inner sides 26, 27 of the clamping jaws 20, 21, which said inner sides clamp a workpiece W. Two steps 28, 29 are formed on each of the inner sides 26, 27 in the embodiment according to FIG. 3, the steps 29 being located closer to the shaft 11 of the saw blade 10 than the steps 28. Lying on the step 29, a workpiece W is clamped, which has a greater width b1 than a workpiece W of a smaller width b2. A workpiece W of a smaller width b2 is clamped lying on the steps 28. A workpiece W whose width b3 is even smaller than the width b2 is clamped lying on the disk 3 in the usual manner next to the steps 28, 29 or under the steps 28, 29 in FIG. 1 and FIG. 2. A notch 30 is formed there on the inner side 26 or additionally on the inner side 27 for clamping workpieces W with round profile.

With a given diameter D of the saw blade 10, a comparatively broad workpiece W can also be cut over the entire width due to the steps 28, 29.

A guide rod 31 (see FIG. 1 and FIG. 2) is fastened to the clamping jaw 21 by means of a screw 32. A stop piece 33 for the workpiece W is mounted displaceably at the guide rod 31 and can be fixed by means of a member 34. A length marking may be provided at the guide rod 31. The cutting of a plurality of workpieces W over the same length is thus possible.

The mode of operation of the means described is essentially as follows:

In the case of a miter cut setting of, e.g., +45° according to FIG. 1, the disk 3 is rotated with the workpiece W chucked by +45° in relation to the center position in FIG. 2. The saw head 2 is displaced along the tilt axis 4 by means of the operating part 9 in the direction V+ to the extent that the saw blade 10 is located very close to the front side 24 of the clamping jaw 20, i.e., it cuts the workpiece W very close in the area of the overhang over the front side 24 on tilting the saw head 2 in the direction K+, but without chafing on the front side 24. The rest W′ of the workpiece W hanging over the front side 24 is severed in the tilted-down position of the saw head 2 shown in FIG. 1. The saw blade 10 now plunges into the trough 19.

If a straight cut is to be performed on the workpiece W (see FIG. 2), the rotary disk is brought into the center position (see FIG. 2), and the saw head 2 and hence the saw blade 10 are displaced in the direction V- to the extent that the saw blade 10 will again be located very close to the clamping jaws 20, 21, especially at the acute-angled ends of the clamping jaws 20, 21 in this case. When the saw head 2 is tilted down in the direction K+, the saw blade 10 will cut off the workpiece W directly in front of the clamping jaws 20, 21. The overhanging rest is designated by W′. The saw blade 10 also plunges into the trough 19 in this case.

The center line 23 is the center line of the workpiece W in both cases. After the straight cut according to FIG. 1 and FIG. 2, the saw head 2 is pivoted up in the direction K−.

If a miter cut is to be performed at −45°, the rotary disk 3 is rotated from the central position according to FIG. 2 opposite the direction of rotation by which the position according to FIG. 1 can be reached. The front side 25 of the clamping jaw 21 will then come into a position parallel to the plane of the saw blade 10. The saw head 2 and consequently the saw blade 10 are then again displaced by means of the operating part 9 such that it will meet the workpiece W as close to the front side 25 as possible on tilting the saw head 2 in the direction K+.

It is also possible to set miter angles and countermiter angles that are smaller than +45° and −45°. It is also possible to design the oscillating saw such that miter angles and countermiter angles greater than ±45° can also be obtained.

Using the oscillating saw being described, it is also possible to form on a workpiece W a tip that is symmetrical to the center line W and forms an angle of up to w1 in relation to the center line 23, on the one hand, and an angle of up to w2 in relation to the center line 23, on the other hand, without the workpiece having to be rechucked. Starting from the miter cut according to FIG. 1, at an angle of, e.g., 45°, the saw head 2 is tilted up for this purpose in the direction K- and the disk 3 is then rotated beyond the center position (see FIG. 2) until the countermiter angle, e.g., −45°, is set, at which the front side 25 is parallel to the saw blade 10. After performing the additional cut by tilting the saw head 2 in the direction K+, the countermiter is then cut, so that a 90° tip will be formed on the workpiece W.

The tilt axis 4 coincides with the line along which the saw head 2 is displaced in the arrangement being described. However, it is also possible to design the oscillating saw such that the line along which the saw head 2 is displaced in relation to the bottom plate 1 is parallel to the tilt axis 4.

Means other than the threaded spindle 7 may also be provided for the linear displacement of the saw head 2 in relation to the bottom plate 1. The only thing important for these means is that the saw head 2 be able to be displaced linearly in relation to the bottom plate 1 in the direction of the double arrow V.

While a specific embodiment of the invention has been shown and described in detail to illustrate the application of the principles of the invention, it will be understood that the invention may be embodied otherwise without departing from such principles.

What is claimed is:

1. An oscillating saw comprising:
a saw head, which is tiltable around a horizontal tilt axis and carries a saw tool;
a bottom plate;
a disk, which is rotatable at said bottom plate around a vertical axis;
a clamping device for the workpiece, said clamping device being arranged at said disk, said saw head being linearly and horizontally displaceably mounted at said bottom plate such that a distance between a workpiece chucked in the clamping device and the saw tool is minimal.

2. An oscillating saw in accordance with claim 1, wherein said saw head is displaceable at the bottom plate in parallel to the horizontal tilt axis.

3. An oscillating saw in accordance with claim 1, wherein the saw head is displaceable along a horizontal tilt axis of said saw head.

4. An oscillating saw in accordance with claim 1, further comprising an operating part for setting a displaced position of said saw head.

5. An oscillating saw in accordance with claim 1, further comprising a threaded spindle for the linear displacement of said saw head.

6. An oscillating saw in accordance with claim 4, further comprising a threaded spindle for the linear displacement of said saw head wherein said threaded spindle is connected to said saw head and is connected to said bottom plate such that said saw head can be displaced linearly in relation to the bottom plate via said operating part.

7. An oscillating saw in accordance with claim 1, wherein said clamping device has a pair of clamping jaws, which are adjustable symmetrically and in opposite directions in relation to a center line.

8. An oscillating saw in accordance with claim 7, wherein said clamping jaws have inner sides for clamping the workpiece said inner sides having the same distance from the center line in each position of the clamping jaws.

9. An oscillating saw in accordance with claim 7, wherein the center line intersects the vertical axis around which the disk is rotatable.

10. An oscillating saw in accordance with claim 7, wherein the center line meets an area under the shaft of the saw tool approximately in the middle.

11. An oscillating saw in accordance with claim 7, wherein the two clamping jaws are mounted displaceably at the disk and are adjustable together by means of an adjusting member arranged at the disk.

12. An oscillating saw in accordance with claim 7, wherein front sides at the two clamping jaws, which said front sides face the saw tool, extend at an acute angle in relation to the center line.

13. An oscillating saw in accordance with claim 1, wherein the disk is rotatable by at least +45° in relation to a central position and by at least −45° in relation to the central position.

14. An oscillating saw in accordance with claim 12, wherein the acute angles equal at least 45°.

15. An oscillating saw in accordance with claim 1, wherein the clamping device has at least one step at each of its said two clamping jaws and the workpiece can be placed on one or both step.

16. An oscillating saw in accordance with claim 7, further comprising a guide rod with a stop piece for the workpiece displaceably arranged thereon, said guide rod being fastened to at least one of the clamping jaws.
